(19) United States
(12) Patent Application Publication
(10) Pub. No.: US 2011/0287872 A1
(43) Pub. Date: Nov. 24, 2011

(54) Detachable sports goal net device and system

(76) Inventor: Peter G. Lynch, Chester Springs, PA (US)

(21) Appl. No.: 12/800,628

(22) Filed: May 19, 2010

(51) Int. Cl. A63B 63/00; B23P 11/00

(52) U.S. Cl. 473/478; 29/428

(57) ABSTRACT

A sports goal net system including a removable net component that may be installed and removed quickly and easily by one person from the goal structure or frame as desired, where netting is provided with an attachment component having a zipper that facilitates the connection of the removable net component to a goal structure, such as the frame or posts of a sports goal, the net component being attachable by moving the slider of a zipper along the edge of the attachment component to secure the attachment component to itself so that the attachment component surrounds the goal structure to secure the net assembly to the goal.

### BACKGROUND OF THE INVENTION

1. Field of the Invention

The present invention relates to the field of sports goal nets, such as, for example those used for lacrosse, hockey and soccer, and more particularly to a sports goal net system having a removably provided net that is easy to attach and remove.

2. Brief Description of the Related Art

Sports goals are widely used in connection with a number of sports, including, in particular, lacrosse, soccer and hockey. Sports goals routinely are constructed using a frame, which may be wood or metal, with netting held on the frame. Generally, the netting openings are sized so that the sport object, such as a ball or puck, will remain contained when it is forced against the netting, such as when a player makes a shot. However, in many cases the sports are played outdoors and, as a result, the goal and netting are exposed to the elements. Sports goal frames and nets are generally cumbersome to take indoors and are left out in the open. As a result, the components including the netting often are prone to damage, including not only by the elements such as weather conditions, but also animals, vandalism and even theft.

The netting of a goal when worn may be replaced. U.S. Pat. No. 5,476,266 relates to soccer goals and provides c-shaped channels and a plurality of hanger elements that are designed to hold the net and be insertable into the c-shaped channels. Metal hooks also have been used to secure a net to a frame of a goal structure, such as the hooks disclosed in U.S. Pat. No. 3,507,494. Other attempts to secure netting to a goal structure have included straps and spaced apart rings, such as those disclosed respectively in U.S. Pat. No. 5,615,889 and U.S. Pat. No. 5,180,167. One of the most common ways to secure netting to a goal structure is by threading a nylon string through the net to the post, which is a time-consuming effort and needs continuous care and adjustments in order to keep the net secure to the frame system without gaps and holes.

Though a net may be removed from the structure, it is generally difficult to reattach the net, especially if a plurality of clips or fastening elements need to be installed. U.S. Pat. No. 6,113,507 discloses a sports net that incorporates an elastic cord element into the outer perimeter of the net so that the cord will constrict the perimeter of the net so that the net perimeter may be expanded and placed over the goal frame and secured thereon. U.S. Pat. No. 6,723,011 discloses the use of a hook and loop fastening member that are closed around the frame member in order to secure the netting assembly to the frame. US patent application 2008/0108458 A1 discloses a net assembly that has a plurality of engagement sleeves and includes a detachment seam and a netting material. The '458 application also discloses a zipper but allows for gaps and loose connections at the corners.

Prior netting attempts involve the use of ties to hold the netting onto a goal structure, or even to pass the posts of a goal through openings in the edge of the netting in order to hold the netting onto the goal structure. In many cases, the stress placed on the netting must be directly handled by the netting portion that forms the opening that is placed on the post. The prior nets are often not only prone to breakage, but also are difficult to remove when they are to be replaced. Though some have attempted solutions involving the use of nets which are claimed to be designed for easy replacement, often the netting is held in a manner that the netting or other structures holding the netting may interfere with the goal and the playability of the game with such goals.

A need exists for an improved sports goal net that is easy to configure and that can improve playability of the sport and that does not suffer from the drawbacks associated with the prior goal equipment.

### SUMMARY OF THE INVENTION

A sports goal net apparatus that has a removable netting component that may be installed and removed from the goal structure or frame as desired is provided. The sports goal net apparatus includes netting that has an attachment portion that is designed to attach to a goal structure, such as the frame or posts of a sports goal.

The present sports goal net apparatus provides a zipper to secure the netting component on the goal structure. The sports goal net apparatus provides a continuous attachment locus so that the netting is held along the goal structure with out gaps, seams or holes.

The sports goal net apparatus is configured with a plurality of seating portions that serve to hold the netting and the securing zipper rearward of the goal so that the goal frame remains free of obstruction from the zipper and the attachment component.

The seating portions may further serve as reinforcement zones.

The seating portions may further facilitate installation of the removable net component on the goal structure.

The seating portion may also come in colors and advertise schools, clubs, logos, and names.

Preferably, the seating portions are provided at designated locations along the sports goal net apparatus to facilitate the installation and removal of the netting component so that the zipper may be used to attach the net assembly to the goal structure, with the seating portions providing zones for permitting the further travel of the zipper at the corners of the goal frame or structure.

The seating portion may facilitate improved handling of force loads that are exerted upon the netting and attachment portion, since the netting may be attached along the seating portion as well as along other portions of the netting component.

According to a preferred embodiment, the seating portions are configured to be removable with the netting component.

According to preferred embodiments, the seating portions may provide force handling benefits, including increased resistance to the forces imparted on the assembly at those locations, including on the netting component or netting itself, when a sports implement, such as a ball or puck, is projected into the net.

The netting component and attachment component preferably are constructed from materials that can withstand exposure to sunlight, water, wind and other conditions. The ability to readily remove the netting component from the goal structure, in addition to any beneficially suitable materials from which the netting assembly may be constructed, prolongs the useful life of the apparatus, including the netting component.

According to preferred embodiments, the sports goal net assembly is constructed so that the playability of the sport is not adversely affected by the presence of the attachment component or netting component. For example, according to one preferred embodiment, the attachment component preferably is configured so that it may be secured on the goal structure without protruding into the goal area in manner that would otherwise tend to potentially interfere with balls or pucks entering the goal along the edges of the net.

According to a preferred embodiment, the netting component may include a drawstring mechanism to draw the netting rearward of the goal front to provide tension on the netting. Preferably, the drawstring mechanism may be provided at the net seams. The drawstring mechanism is designed to improve and enhance playability using the net system.

According to one embodiment, the netting component includes a zipper that is provided around the perimeter of the netting so that the zipper may be pulled closed to secure the netting along with the attachment component and the seating portions on the goal frame structure. The zipper may be pulled to close the attachment portion around the goal structure, such as, for example, a goal post, so that when the zipper is pulled from one end of the goal structure to the other, upon reaching the other end, the netting component is securely attached to the goal frame structure. In addition, a drawstring mechanism may be used to draw the net taut and away from the frame.

According to an alternate embodiment, the zipper attachment may be provided to secure the netting component along the front portions of the goal structure, and may utilize additional securing elements, such as spikes, or the like, to secure the sides and/or rear of the netting component to the goal structure portions that rest on the ground. This may be preferable for larger goals, or where the goal includes structure that is already secured to the ground and may be difficult to lift.

According to some embodiments, the netting component and goal frame may be provided together, and may, for example, be supplied in a kit with a goal frame.

According to other embodiments, the invention provides a netting assembly that may be configured to be installed on existing goal structures to replace other netting.

Preferably, the netting component is configured for installation onto standard size sports goals but also may be provided for goals of other sizes.

### BRIEF DESCRIPTION OF THE DRAWING FIGURES

FIG. 1 is a front elevation view of a sports goal system according to my invention, illustrated in a configuration as a lacrosse goal.

FIG. 2 is an enlarged sectional view of the area in the circle 2 of FIG. 1, viewing the portion of the sports goal system from the rear and at an angle to better illustrate the retraction portion, and showing the attachment portion partially cut away to expose the goal post.

FIG. 3 is a right side elevation view of the sports goal system of FIG. 1.

FIG. 4 is a top plan view of the netting assembly shown separate from the goal structure.

FIG. 5 is a front perspective view of a goal structure shown separate from the netting assembly.

FIG. 6 is a sectional view taken along the line 6-6 of FIG. 1.

FIG. 7 is a sectional view taken along the line 7-7 of FIG. 1 through the corner location.

FIG. 8 is an enlarged view of a portion of the attachment component showing the zipper assembly.

FIG. 9 is a right side partial sectional view of a portion of the netting and post of the sports goal system shown in FIG. 1, showing a preferred configuration for attachment of the netting to the attachment component.

FIG. 10 is a right side perspective view of the sports goal system shown in FIG. 1, as viewed from the back of the goal.

FIG. 11 is a top plan view of the sports goal system of FIG. 1.

FIG. 12 is an enlarged front elevation view of the sports goal assembly of FIG. 1 showing the upper right corner of the goal in a partial view separate from the remainder of the goal.

FIG. 13 is a front elevation view of an alternate embodiment of a sports goal assembly according to my present invention.

FIG. 14 is an alternate embodiment of a sports goal assembly viewed from the rear and shown in a perspective view looking at the assembly from above the back end of the goal.

FIG. 15 is a plan view of the netting assembly of the alternate sports goal assembly of FIG. 14, the netting assembly being shown separate from the goal frame structure and viewed looking at the rear of the netting assembly.

FIG. 16 is a right side elevation view of the alternate sports goal system of FIG. 14.

FIG. 17 is an enlarged partial view of the upper right corner of the sports goal assembly of FIG. 14, taken of the encircled area 17 of FIG. 14.

FIG. 18 is an enlarged partial view of the rear of the sports goal assembly of FIG. 14, showing a preferred embodiment of a drawstring closure mechanism.

### DETAILED DESCRIPTION OF THE PREFERRED EMBODIMENTS

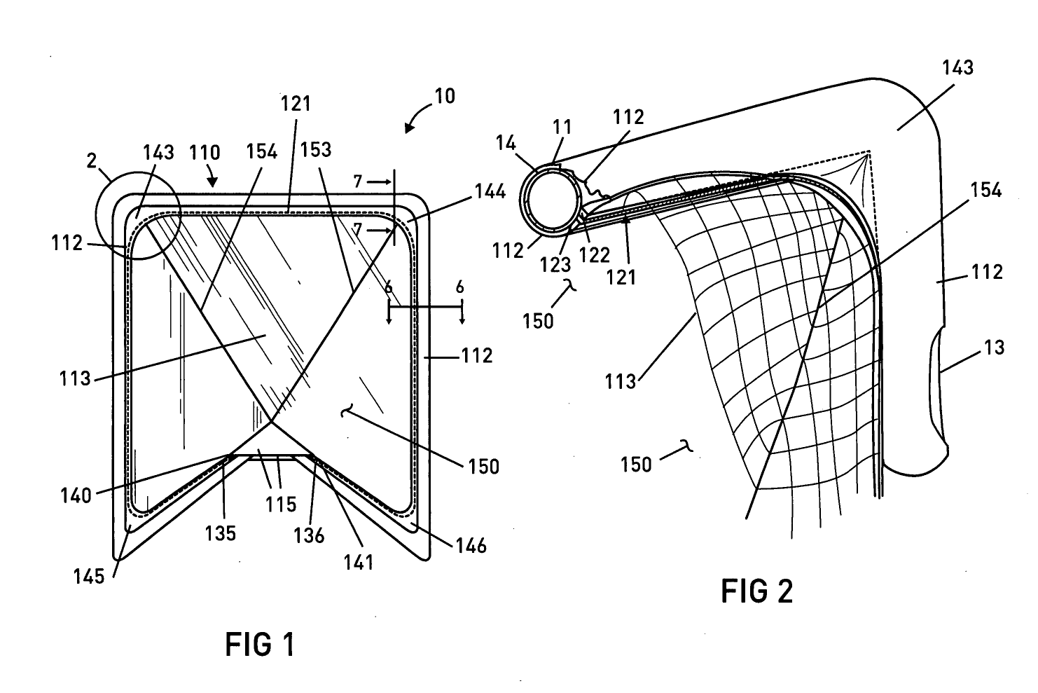

Referring to FIG. 1, there is illustrated a preferred embodiment of a sports goal system 10. The sports goal system 10 is shown including a netting assembly 110 installed on a goal frame structure 11 (FIG. 5). The sports goal system 10 is illustrated configured as a lacrosse goal, which is shown in a preferred configuration in FIG. 4 having a front frame portion including a right side post 12, a left side post 13 and a cross bar 14 with a bottom frame portion including a left base section 16, a right base section 17 and a rear structure 15 connecting the base sections 16, 17. The rear structure 15 may be a frame portion or other element that connects with the right base section 17 and the left base section 16. Preferably, the rear structure 15 provides stability at the rear of the goal. According to a preferred exemplary goal frame structure 11, the front posts 12, 13 and cross bar 14 preferably connect with each other to form the front frame portion. The goal frame structure 11 has a right goal frame upper corner 18, a left goal frame upper corner 19, a right goal frame lower corner 20 and a left goal frame lower corner 21. Though the goal frame structure 11 is shown having a configuration of a lacrosse net, the sports goal frame structure alternatively may be configured as a goal for use with other sports, such as, for example soccer, hockey and the like. For example, in FIG. 13, there is illustrated a sports goal 200 suitable for soccer that is used in connection with a netting assembly 213.

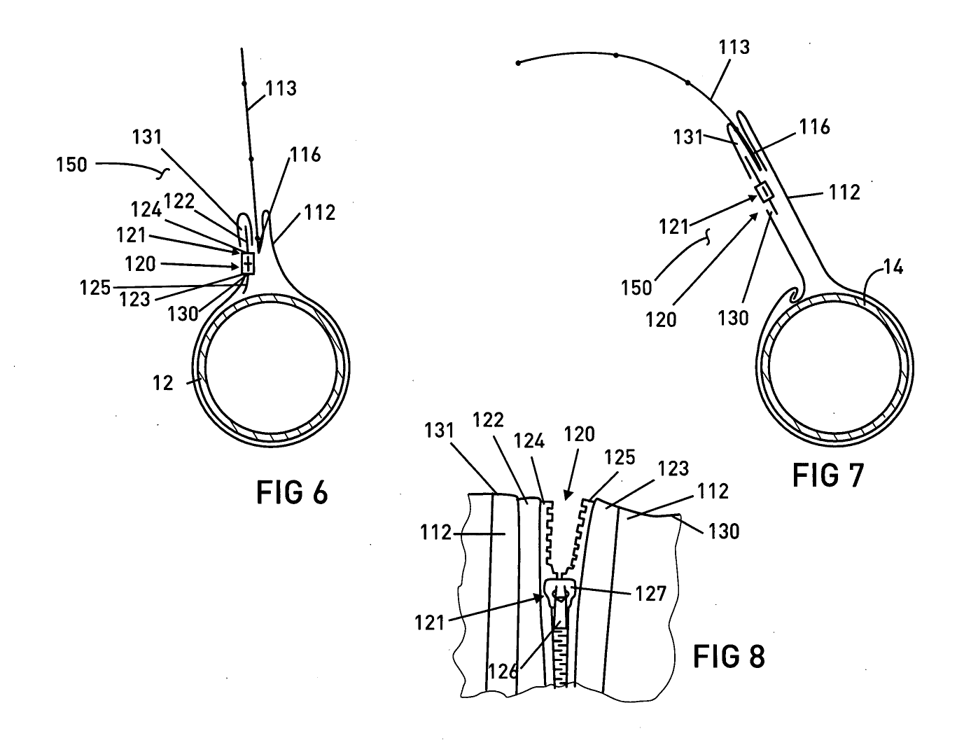

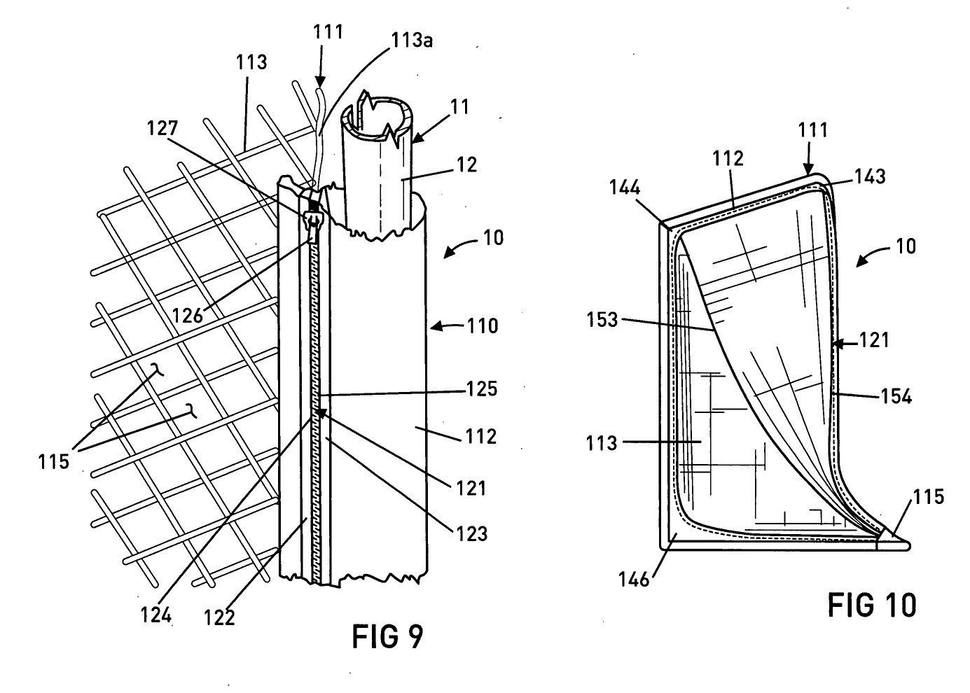

FIG. 5 shows the goal frame structure 11 separate from the netting assembly 110. The netting assembly 110 is shown in FIG. 4 separate from the goal frame structure 11. Though the netting assembly 110 is shown laid out in FIG. 4, it may be folded, for example, to facilitate for storage or transport of the netting assembly 110. The netting assembly 110 preferably includes a netting component 111 and an attachment component 112. The netting component 111 preferably comprises netting 113 having a plurality of openings 115 and which is secured to the attachment component 112. The netting component 111 preferably is provided having a configuration that is compatible with the perimeter and dimensions of the goal frame structure 11. The netting component 111, according to a preferred construction, as shown in FIG. 9, may be connected along its edges 113a to the attachment component 112, which may be done with stitching, adhesive, rivets or other suitable attachment elements or binding. For example, as illustrated in the sectional view of FIGS. 6-8, the netting component 111 preferably may have an edge or binding 116 that may be secured to the attachment component 112. Preferably, the attachment component 112 is configured to have a dimension sufficient to surround the goal frame structure portion, such as the front posts 12, 13, base sections 16, 17 and cross bar 14. The attachment component 112 includes a connecting mechanism 120 that permits the attachment component 112 to be secured along its length to the goal frame structure 11. The attachment component 112 preferably may be constructed from a fabric, such as, for example, nylon, polyester, cotton, plastic or other material that is flexible and, optionally, may be treated with a water or weather resistant compound.

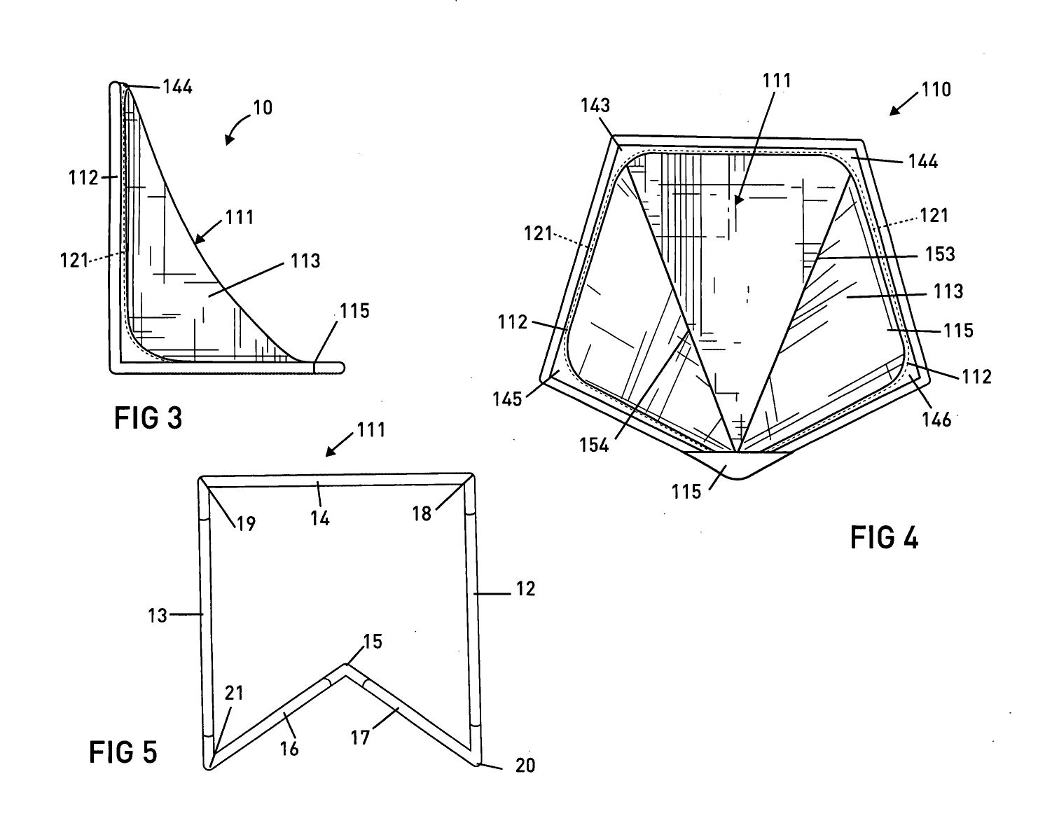

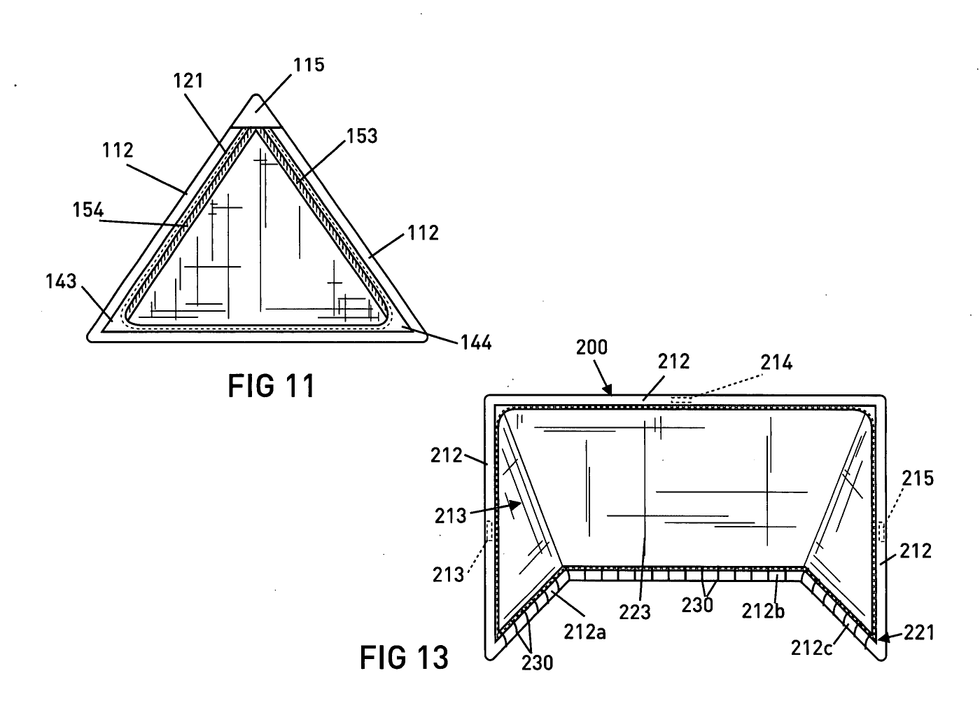

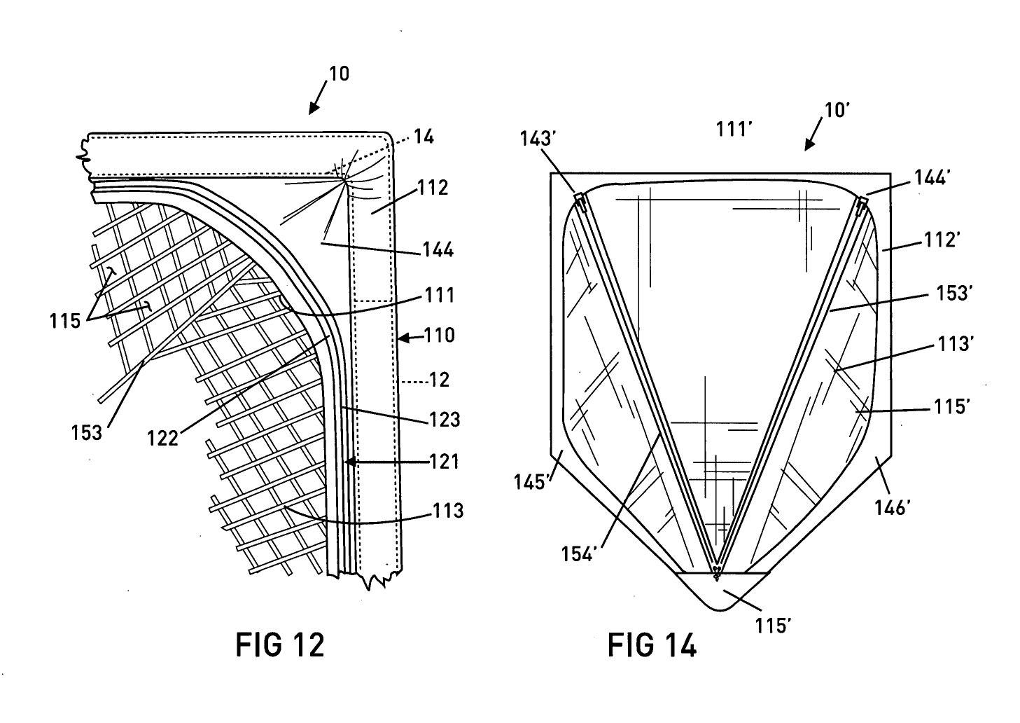

According to the embodiment illustrated in FIGS. 1-12, the attachment component connecting mechanism is configured having a zipper 121 which includes a first zipper part 122 and a second zipper part 123. As best shown in the enlarged view of a preferred configuration in FIG. 8, the first zipper part 122 and second zipper part 123 include teeth 124, 125, respectively, provided along the length of the zipper 121. The zipper 121 includes a zipper pull 126 and slider 127. The slider 127 is provided on one of the first zipper part 122 and second zipper part 123. The first zipper part 122 may be configured as a tape that is attached to the attachment component 112, and the second zipper part 123 also may be configured as a tape that is attached to the attachment component 112. Suitable attachment mechanisms, such as, for example, stitching, adhesive or other suitable attachment components, or combinations thereof, may be used to secure the zipper parts 122, 123 to the attachment component 112. The attachment component 112 has a first edge 130 and a second edge 131 which are arranged around the goal frame structure 11 and secured with the zipper 121. According to a preferred embodiment illustrated in FIG. 1, the attachment component 112 is shown provided along the netting assembly 110 along the length of the cross bar 14, the right post 12, the left post 13 and each base section 16, 17. The zipper 121 preferably is provided with stops, including a first stop 135 and a second stop 136, respectively at the first zipper end 140 and the second zipper end 141. The stops 135, 136 regulate the movement of the zipper slider 127 to keep it within the span of the zipper 121 teeth. The zipper 121 preferably is provided so that it may be closed (for example by pulling) to secure the netting assembly 110 on the goal frame structure 11. Preferably, the zipper 121 and attachment component 112 are arranged to eliminate or minimize restrictions on the goal space 150 so that a sport implement, such as a ball or puck, when entering the goal is not inhibited by the attachment component 112 or the zipper 121. According to preferred embodiments, the zipper 121 is arranged on the attachment component 112 to be situated behind the goal frame structure 11 when the netting assembly 110 is installed so that the zipper 121 remains out of the way of the goal space 150 and, preferably, remains free from the position of the goal space 150 that is proximate to the goal frame structure 11. FIG. 2 illustrates a preferred embodiment of the system 10 with the net assembly 110 having a preferred configuration that is designed to locate the netting 113 and zipper 121, behind the front of the goal when the netting assembly 110 is installed on the goal frame structure 11.

As illustrated in the enlarged view of FIG. 2, the goal frame structure 11 is shown with the cross bar 14 surrounded by the attachment component 112. The attachment component 112 preferably has a plurality of seating portions, such as those 143, 144 that are provided at the upper corners of the goal 10. The seating portions 143, 144 serve to retain the attachment mechanism 120, such as the zipper 121 and the attachment component 112 from interfering with the interior of the goal space 150 that is proximate to those areas of the goal where the goal frame structure 11 turns or changes directions, such as, at the top corners of the goal (e.g., the right corner 18 and left corner 19). FIG. 2 shows a seating portion 143 at the upper left corner of the goal. The seating portion 143 preferably is configured so that the attachment mechanisms 120 may be provided in a manner such that the playability of the sport is not adversely affected by the attachment component 112, zipper 121 or netting component 113. The attachment component 112 preferably is configured with the seating portion 143 and the zipper 121 so that the zipper 121 may be pulled to close the attachment portion 112 securely around the goal frame structure 11, such as, for example, the cross bar 14 and goal post 13 shown in FIG. 2, so that when the zipper 121 is pulled from one end of the goal frame structure 11 to the other to close together the zipper first part 122 and zipper second part 123, upon reaching the other end, the netting component 111 becomes securely attached to the goal frame structure 11.

The seating portions 143, 144 further serve to facilitate the force handling from force loads that may be exerted on the netting 113, such as those forces from a ball or puck, or even from players falling into the netting 113. The seating portions 143, 144 generally are disposed in locations of the goal that traditionally are exposed to the most stress, as, accordingly, preferred scoring areas of the goal may be the goal corners. The seating portions 143, 144, on their sides facing the front of the goal, preferably may be configured with targets imprinted on the corners to provide a training net. The target area may be provided on corners, on the seating portions 143, 144, and for example, may be imprinted with target indicia. Preferably, the target remains located behind the plane of the goal post. The force distribution at the corner locations preferably is handled over the seating portion 143. The seating portions 143, 144 may comprise zones along the netting assembly 111 that serve to reinforce the netting assembly 111. The seating portions 143, 144 may be contoured to cooperate with the goal shape and the shape and layout of the netting 113 when the netting is installed on the goal frame structure as part of the netting assembly 111. The seating portions 143, 144 may be tapered toward the goal corner so as to provide a matching contour with the goal space that the netting 113 defines. The seating portions 143, 144 preferably are continuous with the attachment component 112 so that the netting 113 and other components of the netting assembly 111 form a continuous barrier at the goal frame structure 11 between the attachment component 112 and the netting 113.

According to the preferred embodiment illustrated in FIGS. 1-12, the lacrosse goal 10 has a rear structure 15 that secures the base sections 16, 17 together at the rear of the goal. The netting 113 may be held at a location along the base of the goal, such as, for example, the rear netting structure 115, where the netting 113 may be further secured in a manner that draws the netting 113 at the corners, such as at the upper right goal frame corner 18 and upper left goal frame corner 19. As shown in FIGS. 1, 2, 4, and 10-12, the netting 113 preferably has seams 153, 154 that provide a shape to the netting 113 and helps to define the interior goal space 150.

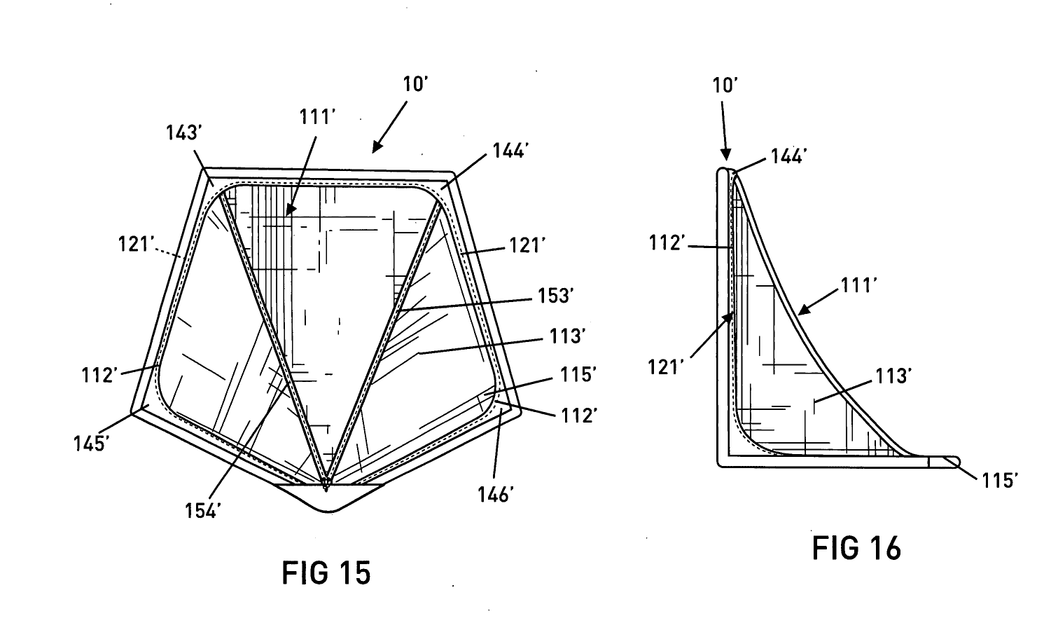

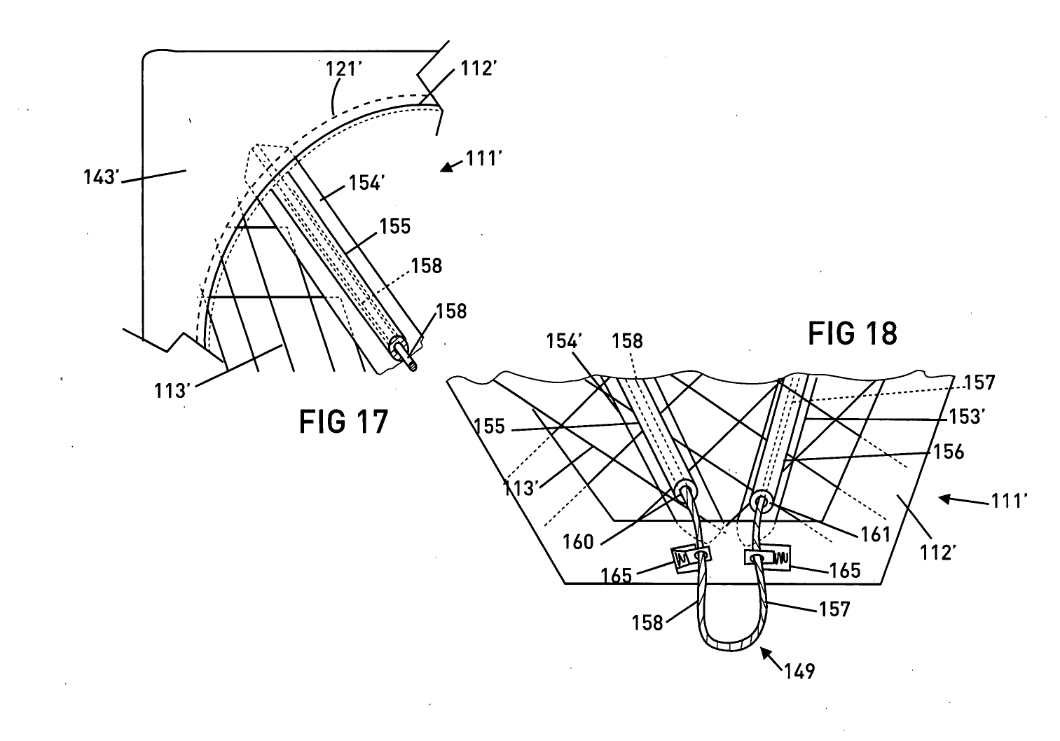

According to a preferred embodiment, as shown in FIGS. 14-18, a sports goal system 10′ is provided with a netting assembly 111′ having drawstring mechanism 149′ provided to facilitate the positioning of the netting 113′, and preferably, for drawing the netting 113′ and attachment component zipper 121′ in a direction rearward of the front of the goal and the goal posts. The preferred embodiment illustrates the net seams 153′, 154′ being constructed with channels 155, 156. The channels 155,156 may be formed with the material used to construct the attachment component 112. A drawstring element 157, 158 preferably is disposed in each respective channel 155, 156. Each drawstring element 157, 158 preferably is attached to a respective seating section 143′, 144′, and preferably is connected at a location proximate to the edge of the seating section closest to the netting 113′. The drawstring elements 157, 158 preferably are provided having a suitable length, so that they may emerge from the channels 155, 156 at the lower portion of the netting assembly 111′ at the rear netting structure 115′. According to a preferred embodiment, the rear netting structure 115′ is provided having two grommets 160, 161 provided for the drawstring elements 157, 158 to pass through, respectively, so that the drawstrings may be tensioned by pulling to draw the netting 113′ rearward along with portions of the attachment component 112′, tighten the netting 113′ to remove slack, and secure the drawstring elements 157, 158 at the rear of the goal. For example, one suitable way of securing the drawstring elements 157, 158 may involve tying them together. Other suitable methods may be used, including providing the drawstring elements 157, 158 with fastenable end elements. The drawstring elements 157, 158 may be lengths of string made from nylon, polyester, cotton, polyethylene, or other suitable material. Accordingly, the net seams 153, 154 shown and described in the embodiment illustrated in FIGS. 1-12, may also be used in the configurations with a drawstring mechanism, such as the drawstring mechanism 149, and the seams 153, 154, may be provided on the sports goal system 10 in the same manner as those seams 153′, 154′ shown and described in connection with the system 10′ of FIGS. 14-18.

Alternately, the drawstring elements 157, 158 may be continuously provided as a single length element, as shown in FIG. 18, where the drawstring elements 157 and 158 are joined together. A retaining mechanism, such as, for example, the clips 165, provided to secure each drawstring element 157, 158 at a desired location relative to the grommets, 160, 161. Preferably, the clips 165 are spring loaded and may be moved along the drawstring elements 157, 158, and slid to a desired position, such as, for example, where the clips 165 engage the grommets 160, 161, so that the netting 113′ may remain taut as forces are received on the netting 113′.

The rear netting structure 115 may be constructed from a rigid material, such as plastic, or according to the preferred embodiment may be constructed from a fabric type material, such as nylon or canvas. The netting 113 preferably is secured to the rear netting structure 115. This may be done by securing the netting 113 directly to the rear structure 115 or may be accomplished with the attachment component 112 being secured to the rear structure 115 and the netting 113 secured to the attachment component 112.

According to a preferred embodiment, the zipper 121 is connected to the attachment component 112 so that the zipper first part 122 and zipper second part 123 may be continuously secured along the length of the zipper 121. The zipper 121 is provided continuously including along the seating portions 143, 144, so that the netting assembly 111 may be secured to the goal frame structure 10 from the interior of the goal space 150. The preferred embodiment shown in FIG. 2 includes a rear netting structure 115 that connects with the netting 113, the attachment portion 112 or both. The rear netting structure 115 according to preferred embodiments may be provided as part of the attachment component 112. The rear netting structure 115 may serve as the initial point of attachment for the netting assembly 111 when the netting assembly 111 is installed on the goal frame structure 11.

The sports goal system 10 may be used by providing or assembling a goal frame structure 11. The goal frame structure 11 may be an existing structure, may be supplied in a kit form with the netting assembly 111, or may be separately provided. As a replacement net system to an existing goal system. The netting assembly 111 preferably is stored in a folded condition, and may be unfolded for installation onto the goal frame structure 11. Preferably, the netting assembly 111 is laid out on a surface near the goal frame structure 11, such as the playing surface, and the orientation of the netting assembly 111 is aligned with the position and shape of the goal frame structure 11 (FIG. 5).

The installation of the netting assembly 111 on the goal frame structure 11 is accomplished by placing the attachment component 112 around the goal frame structure 11, and securing the attachment component 112 edges together by moving the zipper slider 127 along the zipper teeth 124, 125.

According to one preferred method of installation, the goal frame structure 11 is tilted so that the connecting portion 15 is raised from the ground 500 or playing surface a sufficient distance from the ground 500 to place the rear netting structure 115 over the far end or connecting portion 15 of the goal frame structure 11. This may be done by an individual from inside the goal frame structure 11. Once the rear netting structure 115 is placed over the far end 15 of the goal frame structure 11, then, according to a preferred installation method, the netting assembly 111 is placed under the lower goal frame corners 20, 21 and over the respective goal frame upper corners 18, 19. The zipper 121 is then pulled from the inside of the goal space 150, preferably, from one end 140 to the other end 141, along the attachment portion 112 to secure the netting assembly 111 to the goal frame structure 11. Alternately, the zipper 121 may be closed as the netting assembly 111 is positioned over one or more of the goal frame corners 18, 19, 20, 21, or other suitable order where the netting component 111 may be attached to the goal frame structure 11. The zipper 121 is then matched by placing the zipper slider 127 on both of the rows of zipper teeth 124, 125, at the starting location on the attachment component 112, which, according to the preferred embodiment illustrated in FIGS. 1-11, is at the rear of the goal behind the lower left frame corner 21. The zipper pull 126 is moved along the attachment component 112 and the slider 127 pulls together the zipper teeth 124, 125 to secure the first zipper part 122 and second zipper part 123 together so that the attachment component 112 surrounds the goal post base section 16. The zipper pull 126 and slider 127 are moved along the remaining goal frame structures (e.g., the left goal post 13, the cross bar 14, the right goal post 12, and the right base section 17), and the completion of the zippering of the attachment component 112 on the remaining goal frame components secures the netting assembly 111 on the goal frame structure 11. Preferably, two zipper slider 127 and pull 126 pairs are provided to function as a double zipper mechanism, to allow the pulling to be accomplished from either the right or left side of the netting assembly 111.

According to a preferred embodiment, the netting assembly 111 is configured so that the zipper 121 turns at the location where the attachment component 112 engages the lower left corner 21 of the goal frame structure 11. At the lower left goal corner, a seating portion 145 of the attachment component 112 is illustrated, with another seating portion 146 provided at the lower right goal corner. The attachment component 112 preferably is secured to the lower left base section 16 and the zipper slider 127 is moved forward along the base section 16, the left post 13, the cross bar 14, and the right post 12, until the slider 127 reaches the stop 136 at the other side of the, at the rear of the goal base section 17. The netting assembly 111 therefore is installed on the goal frame structure 11, and the netting assembly 111 may be additionally secured to the rear structure 15, as needed. For example, in some installations, the netting assembly 111 may be provided with a portion, such as the rear netting portion 115, that may be installed on the rear structure, while in other cases, the netting assembly 111 may be constructed with the attachment component 112 configured to meet at each end, and, optionally, though not illustrated, the attachment component 112 may be secured at its ends to itself or the goal structure, or both.

According to an alternate embodiment illustrated in FIG. 13, a goal frame structure is shown with a netting assembly 213 installed thereon. The netting assembly 213 includes an attachment component 212 which may be constructed similar to the attachment component 112 shown and described in connection with FIGS. 1-12, except that the attachment component 212 is secured on the goal frame right post 215, the goal frame cross bar 214 and the goal frame left post 213. The netting 223 is secured along the base of the goal structure with alternate securing components 230, such as, for example, stakes, clips, spikes or other elements, which may be used to hold the netting 223 at the sides and the rear of the goal. According to one embodiment, the attachment component 212 may be configured to extend on the sides and rear of the goal structure, but the zipper 221 may be provided along the portion of the attachment component 212 that corresponds with the front goal structure, such as, the right goal post 215, left goal post 213 and cross bar 214. For example, in the exemplary embodiment of the goal 200, the base attachment component portions 212a, 212b, 212c do not have a zipper, and are attached to the goal frame using fastening components 230.

Although, the goal frame structure 11 may be provided separately from the other components, the netting assembly 111 preferably is configured to conform to the goal frame dissensions, including, for example, the goal frame part or structure diameter. The netting assembly may be provided for use with a number of frames, including standard regulation size goal frames and other sizes, such as custom or youth sized goal frames. The zipper 121, though illustrated with teeth 124, 125, may be provided as a nylon type zipper (not shown) with interlocking elements along the length of the attachment component 112, such as, for example, a groove and rib design, with a clip for fastening a rib in the groove. The netting assembly may be provided with a goal structure, or may be provided separately, so that in the event that replacement netting assemblies are desired, the goal structure may be maintained and used. In addition, the netting assembly may be provided for use with existing goal structures so that the netting assembly may replace those nets that were previously secured by other means and have ripped or become otherwise damaged and are in need of being replaced. The present invention may further provide a convenient way to replace nets, so that, for example, if a different color net is to be used (for a home or away game) or for different teams playing on the same field, then the netting assembly may be readily replaced with another. For example, team logos or team sponsors may be provided an opportunity to sponsor one game, while other sponsors may sponsor other games, and recognition of the appropriate sponsorship may be accomplished by changing the netting assembly between games. The present invention makes replacing the netting assembly an easy task. Conversely, a team may be able to take charge of securing its netting assembly so that the netting assembly may be removed and safely stored when it is not being used. The invention also affords leagues, townships and other organizations with the ability to lease, sell or rent nets to teams, and have those teams be responsible for the care of the nets, since they can readily attach and remove them.

What is claimed is:

1. A sports goal system with a removable netting component comprising:
a) a goal frame structure comprising at least one structural member configured to form a right goal post, a left goal post a cross bar, a first base section and a second base section; wherein said right goal post with said cross bar forms an upper right corner of a goal, wherein said left goal post and said cross bar form an upper left corner of the goal;
b) a removable netting assembly adapted for selective attachment to and removal from said goal frame structure;
c) the removable netting assembly including netting, an attachment component and a securing mechanism for securing the attachment component on said structural member;
d) said securing mechanism including a first edge formed on said attachment component and a second edge formed on said attachment component, a zipper closure including a zipper slider, a first series of zipper teeth provided along at least one of the first edge of said attachment component and the second edge of said attachment component, and a second series of zipper teeth provided along said attachment component in a location to connect with said first series of zipper teeth;
e) wherein said first series of zipper teeth and said second series of zipper teeth are arranged so that when drawn together by said zipper slider, the attachment component surrounds the goal frame structural member and secures thereto;
f) said attachment component including at least a first seating portion and at least one second seating portion, said first retraction portion being arranged on said attachment component in a location corresponding to the upper right goal corner when the net assembly is installed on the goal frame structure, and said second retraction portion being arranged on said attachment component in a location corresponding to the upper left goal corner when the net assembly is installed on the goal frame structure;
g) wherein said attachment component has a first end and a second end and is continuously provided, said attachment portion having a first portion corresponding with said right base section, a second portion corresponding with said right goal post, a third portion corresponding to said cross bar, a fourth portion corresponding to said left goal post, a fifth portion corresponding with said left base portion;
h) wherein said right base portion and said left base portion of said goal frame structure are secured at the rear of the goal;
i) wherein a first zipper stop is provided on one end of said attachment component and a second zipper stop is provided on the other end of said attachment component; said zipper slider being movable along the first series of zipper teeth and said second series of zipper teeth between said first zipper stop and said second zipper stop;
j) wherein said first series of zipper teeth and said second series of zipper teeth are arranged so that they are provided along the attachment portion and are arranged along the first and second seating portions in a configuration to facilitate alignment of the net assembly zipper components behind the goal frame structure and to dispose the seating portions behind the front of the goal frame structure; and
k) wherein said first series of zipper teeth and said second series of zipper teeth are arcuately arranged along said first seating portion and said second seating portion.

2. The sports goal system of claim 1, wherein said goal system comprises a lacrosse goal.

3. A sports goal net assembly comprising:
a) a removable net component including:
an attachment component for attaching the net assembly to a sports goal structure; and
a zipper configured to connect the removable net component to a goal structure;
b) wherein the zipper is provided along the goal structure for continuous attachment of the net assembly around the goal frame structure.

4. The sports goal net assembly of claim 3, wherein the attachment component includes at least a portion that corresponds with the front of a goal, and wherein the zipper is arranged to be located away from the portion of the attachment component that corresponds with the front of the goal in order to minimize interference with sports implements entering the goal.

5. A sports goal kit with a removable sports goal net assembly that attaches to and detaches from a goal frame structure, comprising:
a) a removable net assembly including an attachment component; and
b) netting;
c) wherein the attachment component is attached to the netting at a first point of attachment and is attached to the goal structure at a second point of attachment;
d) wherein the attachment component further includes a zipper;
e) wherein the zipper is positioned to remain free of contact with a sport implement, such as a puck or ball, upon said sport implement entering the goal.

6. The kit of claim 5, further including an alignment mechanism for aligning the removable net assembly.

7. The kit of claim 6, wherein said alignment mechanism comprises a drawstring mechanism.

8. The assembly of claim 1, further comprising reinforcement portions comprising zones in one or more locations where said goal structure makes a change in direction.

9. The assembly of claim 8, wherein said reinforcement portions are provided with indicia thereon that comprises a target.

10. The system of claim 1, wherein the attachment component is configured to surround the goal structure and wherein the zipper is provided to be located within the goal when the net component is attached to the goal structure and remain substantially rearward of the front of the goal structure.

11. The assembly of claim 3, wherein the attachment component is configured to surround the goal structure and wherein the zipper is provided to be located within the goal when the net component is attached to the goal structure and remain substantially rearward of the front of the goal structure.

12. The system of claim 1, wherein said attachment component comprises a continuous barrier between said goal post and said netting.

13. The assembly of claim 3, wherein said attachment component comprises a continuous barrier between said goal post and said netting.

14. A method of installing sports goal netting on a goal frame structure, the method comprising:
a) providing the sports goal netting assembly of claim 3;
b) arranging the attachment portion on the goal structure; and
c) closing the zipper along its length so that the attachment portion is secured to itself.

15. The method of claim 14, including providing a drawstring mechanism and aligning the netting assembly with said drawstring mechanism.

16. The method of claim 14, wherein closing the zipper is accomplished from the interior of the goal frame.

17. The method of claim 14, wherein the netting assembly includes a rear attachment section and wherein the method includes tilting the goal frame structure to place the rear of the goal frame structure above the ground surface, placing the netting assembly rear attachment section on the rear of the goal frame structure, placing the attachment portion of the netting assembly along the first base section and the second base section so that the attachment portion covers the underside of the base sections, closing the zipper starting from the rear of the goal structure, continuing along at least one first base leg section, continuing upwardly along the adjacent first goal post, continuing along the cross bar, continuing down the adjacent second goal post, and continuing along the adjacent second base leg section.

18. The method of claim 17, wherein the zipper includes a zipper slider, a first row of teeth, a second row of teeth, a first stop and a second stop, the method including bringing together at the first zipper end the zipper teeth and moving the zipper slider from said first zipper end to said second stop.

19. The method of claim 17, wherein the zipper includes a zipper slider, a first row of teeth, a second row of teeth, a first stop and a second stop, the method including bringing together at the first zipper end the zipper teeth and moving the zipper slider from said first zipper end to said second stop.

20. The method of claim 17, wherein the zipper comprises a rib and groove configuration.

21. The assembly of claim 3, wherein the attachment component is configured with a contour that facilitates locating the zipper substantially rearward relative to the front of said goal.

22. The assembly of claim 3, wherein the zipper comprises a double zipper.

23. The assembly of claim 22, wherein said double zipper includes at least two zipper sliders.

24. The assembly of claim 3, wherein the attachment component is continuously provided to cover the goal frame structure, and wherein the attachment component is provided with indicia.

25. The assembly of claim 24, wherein the indicia consists of one or more of a logo, words, a color, an arrangement of colors.

26. The assembly of claim 3, wherein said attachment component includes a plurality of corner sections, each corner section being provided along the length of said attachment component at a location corresponding to the location of a corner of the goal frame structure that corresponds with the netting assembly when the netting assembly is installed thereon, wherein said corner sections are configured to have said first zipper teeth and said second zipper teeth passing therealong.

27. The assembly of claim 3, wherein the removable net component has target indicia on the attachment component at one or more of the upper corners and lower corners.
